(19) United States
(12) Patent Application Publication
(10) Pub. No.: US 2010/0223469 A1
(43) Pub. Date: Sep. 2, 2010

(54) Method, System and Computer Program Product for Certifying Software Origination

(75) Inventors: Riaz Y. Hussain, Austin, TX (US); Phani Gopal V. Achanta, Austin, TX (US); Frank Eliot Levine, Austin, TX (US)

Correspondence Address: IBM CORP. (AUS);C/O MUNSCH HARDT KOPF & HARR, P.C., 3800 LINCOLN PLAZA, 500 N. AKARD STREET, DALLAS, TX, 75201-6659, US

(73) Assignee: International Business Machines Corporation, Armonk, NY (US)

(21) Appl. No.: 12/394,470

(22) Filed: Feb. 27, 2009

(51) Int. Cl. H04L 9/32

(52) U.S. Cl. 713/175

(57) ABSTRACT

The disclosed embodiments present a method, system and computer program product for certifying software origination. The method for certifying software origination comprises generating at least one certificate of originality for a software artifact, generating a key for authenticating the certificate of originality, incorporating the key into the certificate of originality, and embedding the certificate of originality in the software artifact.

### BACKGROUND

It is common in software development to manage ongoing development of application source code that may be worked on by a team of people with a source version control system. Source code is the instructions of a program written in a programming language. A source version control system is an application that provides management of multiple revisions of the same unit of information such as, but not limited to, source code. As software is designed, developed and deployed, it is extremely common for multiple versions of the same software to be deployed in different sites, and for multiple developers to work on the same piece of code.

### BRIEF SUMMARY

According to one embodiment of the present disclosure, a method for certifying origination information about a software artifact is disclosed. The method comprises generating a certificate of originality for a software artifact. The certificate of originality provides information about the developer of the software artifact and/or other information relating to the origination of the software artifact. The method also comprises generating a key for authenticating the certificate of originality, incorporating the key into the certificate of originality, and embedding the certificate of originality in the software artifact.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is an embodiment of network of data processing systems in which the illustrative embodiments may be implemented;

FIG. 2 is an embodiment of a data processing system in which the illustrative embodiments may be implemented;

FIG. 3 is an embodiment of a certificate of originality application;

FIG. 4 is an embodiment of a certificate of originality;

FIG. 5 is an embodiment of a compiled software artifact;

FIG. 6 is an embodiment of a process for generating a certificate of originality for a software artifact;

FIG. 7 is an embodiment of a process for building a software artifact in accordance with the disclosed embodiments; and

FIG. 8 is an embodiment of a process for accessing a certificate of originality of an executable software artifact in accordance with the disclosed embodiments.

### DETAILED DESCRIPTION

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

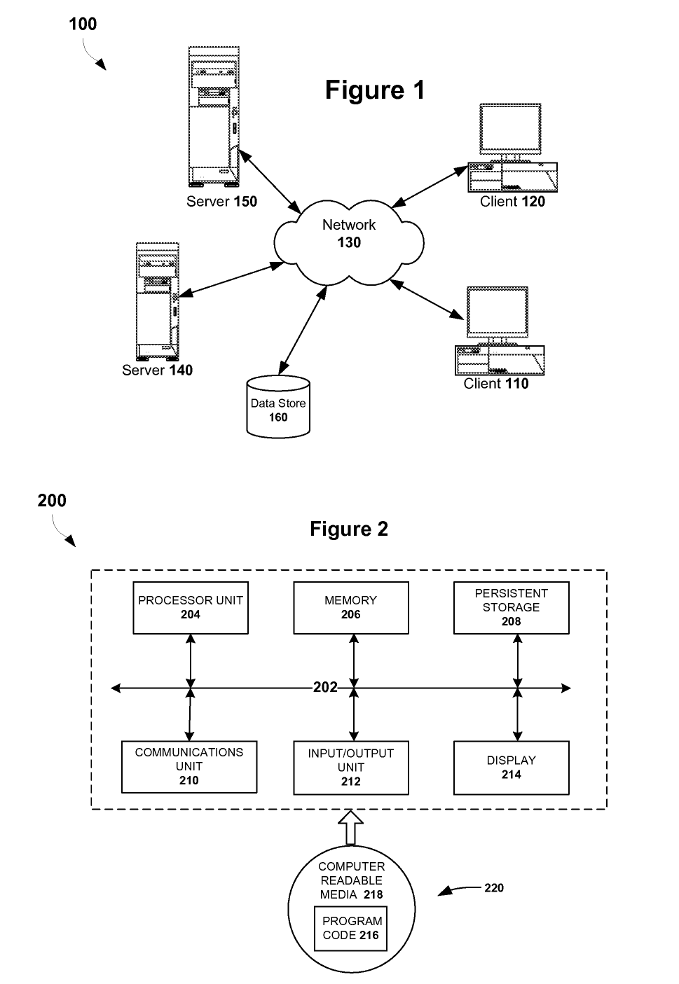

With reference now to the figures, and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a network of data processing systems 100 in which illustrative embodiments may be implemented. Network data processing system 100 contains network 130, which is the medium used to provide communications links between various devices and computers connected together within network data processing system 100. Network 130 may include connections, such as wire, wireless communication links, or fiber optic cables.

In some embodiments, server 140 and server 150 connect to network 130 along with data store 160. Server 140 and server 150 may be, for example, IBM System P® servers. In addition, clients 110 and 120 connect to network 130. Clients 110 and 120 may be, for example, personal computers or network computers. In the depicted example, server 140 provides data and/or services such as, but not limited to, data files, operating system images, and applications to clients 110 and 120. Network data processing system 100 may include additional servers, clients, and other devices not shown.

In the depicted example, network 130 represents the Internet. The Internet is a collection of networks and gateways that uses a variety of data transmission protocols to connect millions of computers together globally, forming a massive network in which any computer can communicate with any other computer as long as they are both connected to the Internet. At the heart of the Internet is a backbone of high-speed data communication lines between major nodes or host computers, consisting of thousands of commercial, governmental, educational and other computer systems that route data and messages. Of course, network 130 may also be implemented as a number of different types of networks, such as for example, an intranet, a local area network (LAN), or a wide area network (WAN). FIG. 1 is intended as an example, and not as an architectural limitation for the different illustrative embodiments.

FIG. 2 is an embodiment of a data processing system in which an embodiment of a certificate of originality application may be implemented. The data processing system of FIG. 2 may be located and/or otherwise operate at any node of a computer network, such as the network illustrated in FIG. 1 (e.g., at clients 110 and/or 120, at servers 140 and/or 150, etc.). In the embodiment illustrated in FIG. 2, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

In some embodiments, memory 206 may be a random access memory or any other suitable volatile or non-volatile storage device. Persistent storage 208 may take various forms depending on the particular implementation. For example, persistent storage 208 may contain one or more components or devices. Persistent storage 208 may be a hard drive, a flash memory, a rewritable optical disk, a rewritable magnetic tape, or some combination of the above. The media used by persistent storage 208 also may be removable such as, but not limited to, a removable hard drive.

Communications unit 210 provides for communications with other data processing systems or devices. In these examples, communications unit 210 is a network interface card. Modems, cable modem and Ethernet cards are just a few of the currently available types of network interface adapters. Communications unit 210 may provide communications through the use of either or both physical and wireless communications links.

Input/output unit 212 enables input and output of data with other devices that may be connected to data processing system 200. In some embodiments, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. For example, a storage device in data processing system 200 is any hardware apparatus that may store data. Memory 206, persistent storage 208, and computer readable media 218 are examples of storage devices in a tangible form.

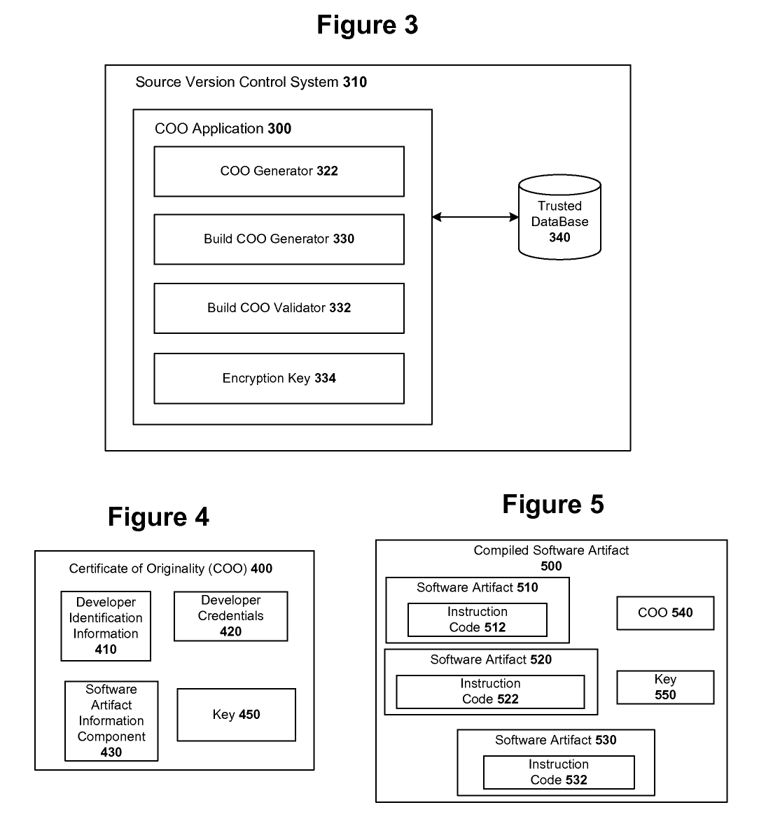

FIG. 3 is an embodiment of a certificate of originality (COO) application 300. In the embodiment illustrated in FIG. 3, COO application 300 is located on and/or is otherwise incorporated into a source version control system 310. Source version control system 310 may be located on any type of computer system (e.g., a server, such as server 140, a client system, such as client 110, etc.). COO application 300 may be employed during, but not limited to, the development process of a software artifact for providing information about the origination of software artifact. An artifact may include any object such as, but not limited to, source code, pictures, html, documentation, binaries, etc. For example, source artifacts are objects in the source tree that are used for building an application such as, but not limited to, source code, help files, message files, makefiles etc. Similarly, executable artifacts are files that are used in an execution environment for an application to work such as, but not limited to, dlls, .exe files, help files, etc. The origination information of the COO may include information such as the software development environment, origins of copied code, licenses to use the code or permission to redistribute the artifact, information about the developers of the artifact, etc. For example, in some embodiments, when a developer creates and/or modifies an artifact (e.g., one or more source code routines written to be compiled by a language compiler, such as C, C++, or Java), the developer certifies that he/she created and/or modified the artifact and identifies any additional information regarding the derivation of the artifact. A developer, as referenced herein, is a person who contributed to the writing and/or modification of the source code of a software artifact. Further, it should be understood that COO application 300 may be located on any type of computer system.

In some embodiments, COO application 300 comprises a COO generator 322. COO generator 322 is used to generate and/or modify a COO for each artifact such as, but not limited to, software artifacts for an application. For example, in some embodiments, each time the software artifact is checked into and/or out of source version control system 310, COO generator 322 creates a COO for the software artifact and/or creates a COO for any change/modification to a software artifact. In some embodiments, COO generator 322 may automatically populate certain fields of information of the COO with origination information (e.g., the developer checking the software artifact into or out of source version control system 310, program details, platform information, build environment, etc.). In some embodiments, COO generator 322 may prompt the developer for particular information to include in the COO. For example, in some embodiments, COO generator 322 may produce and/or otherwise display a template containing predefined fields of information that may be pre-populated with known information and/or fields set to receive information input by the developer. As will be discussed below in further detail, the COO for the artifact is stored as and/or otherwise becomes part of the artifact itself (e.g., embedded in the artifact as metadata, a file, a comment block, etc.).

In addition, in some embodiments, COO application 300 comprises a build COO generator 330. Build COO generator 330 is used to generate a COO for a build artifact (e.g., the integration of multiple artifacts, such as multiple source artifacts, into a software product). In some embodiments, the build COO comprises a summary of information for the build artifact (e.g., a collection of summary information for each source artifact included in the build artifact and/or a summary of information associated with the build artifact itself, such as the owner and/or distributor of the build artifact). In a build artifact, several COOs may be embedded in the build artifact, and COOs may include a hierarchy of COOs. For example, a build artifact that includes a static library would include the COO for the build artifact, a COO for the included library, and a COO for other component(s) included in the build artifact. The COOs may also be summary COOs including a summary of COO information for the included artifacts. As will be discussed below in further detail, in some embodiments, the COO for the build artifact is stored as and/or otherwise becomes part of the build artifact itself (e.g., embedded in the artifact as metadata, a file, a comment block, etc.).

In some embodiments, COO application 300 is used to generate a hash value associated with an artifact (e.g., an artifact component or a build artifact). A cryptographic hash function is a transformation that takes an input and returns a fixed-size string, which is called the hash value. A hash value (also called a “digest” or a “checksum”) is a kind of “signature” for a stream of data that represents the contents. Ideally, every unique input generates a unique hash value. Different types of cryptographic hash functions may be used for generating the hash value such as, but not limited to, the Secure Hash Algorithm (SHA) hash functions designed by the National Security Agency (NSA), an MD5 (Message-Digest algorithm 5), etc. The hash value for the particular artifact may be a hash of a size of the artifact, a hash value of the artifact itself, etc. The hash value of the artifact generated by COO application 300 is included in the COO for the respective artifact. The hash value may then be used as a checksum to verify that the COO embedded with the artifact is valid. For example, in some embodiments, the algorithm used to generate the hash value may also be stored in the COO and can used by a customer and/or recipient of the artifact to generate a hash value corresponding to the artifact. This hash value may then be compared to the hash value stored in the COO and, if they match, the COO is considered certified. The hash value corresponding to the artifact may also be stored in a trusted database 340 (e.g., on source version control system 310, a remote server, or elsewhere).

In some embodiments, COO application 300 comprises a COO build validator 332. COO build validator 332 is used to ensure that each artifact integrated into a build artifact has a valid COO. For example, in some embodiments, in response to the identification of the artifacts that will comprise the build artifact, COO build validator 332 accesses each artifact and verifies that each artifact has a valid COO. In the embodiments described above, COO information is embedded in the artifact itself. However, it should also be understood that in some embodiments, COO information may be stored in a trusted database 340 (e.g., on source version control system 310, a remote server, or elsewhere) in addition to or instead of being embedded in the artifact. For example, if embedding a COO in a particular artifact is undesirable or may adversely affect the operation and/or processing of the artifact, the COO may be stored remote from the artifact (e.g., a picture file) and be accessible in response to a query submitted to a host of the COO information.

In the embodiment illustrated in FIG. 3, COO application 300 also comprises an encryption key 334. Encryption key 334 may comprise the private key of a private-public key pair, key, or any other type of key for digitally signing and/or encrypting the COO for an artifact. For example, in some embodiments, COO application 300 uses encryption key 334 to encrypt the COO. The encrypted COO is then embedded in the artifact. The recipient of the artifact may then use the corresponding public key to decrypt the COO. In some embodiments, if the COO is not embedded in the artifact (e.g., due to performance, processing or other reasons), encryption key 334 may be used to encrypt the hash value of the artifact, and then the encrypted hash value of the artifact may be embedded in the artifact. In this embodiment, the public key may then be used to decrypt the value, and then the value transmitted and/or otherwise communicated to a host system where the corresponding COO for the artifact may be located/identified and returned to the requestor.

FIG. 4 is an embodiment of a COO 400 for an artifact that may be generated by COO application 300. In some embodiments, COO 400 may comprise developer identification information 410, developer credentials 420, and a software information component 430. In some embodiments, developer identification information 410 includes information about the developer that originated and/or modified the source code for the artifact. The developer information may include the developer's name, job title, and/or contact information. In some embodiments, developer identification information 410 may also include additional and/or alternative information. Developer credentials 420 may comprise additional information about the developer such as, but not limited to, the certifications of the developer, where the code was developed, when the code was developed, licensing restrictions associated with the code or artifact, etc. Software information component 430 may provide implementation details about the software artifact such as, but not limited to, the name of the artifact, the number of lines of code in the artifact, comments about the code, sections of the code that are processing intensive, etc. It should be understood that the types of information included in a COO may vary depending on whether the artifact is a source artifact or a build artifact. In the embodiment illustrated in FIG. 4, COO 400 also comprises a key 450 corresponding to the hash value associated with the artifact (e.g., generated by COO application 300).

FIG. 5 is an embodiment of a compiled software artifact 500. Compiled software artifact 500 comprises a build artifact comprising one or more source artifacts such as, but not limited to, software artifact 510, software artifact 520, and software artifact 530. Software artifact 510, software artifact 520, and software artifact 530 respectively comprise instruction code 512, instruction code 522, and instruction code 532. The instruction code may be implemented in any programming language including, but not limited to, Java, C++, C, and even assembly language. In addition, compiled software artifact 500 comprises a COO 540 that may be generated by COO application 300. Compiled software artifact 500 also comprises a key 550 corresponding to the hash value associated with the build artifact (e.g., generated by COO application 300). Key 550 provides a secure mechanism for validating COO 540 of the compiled software artifact 500.

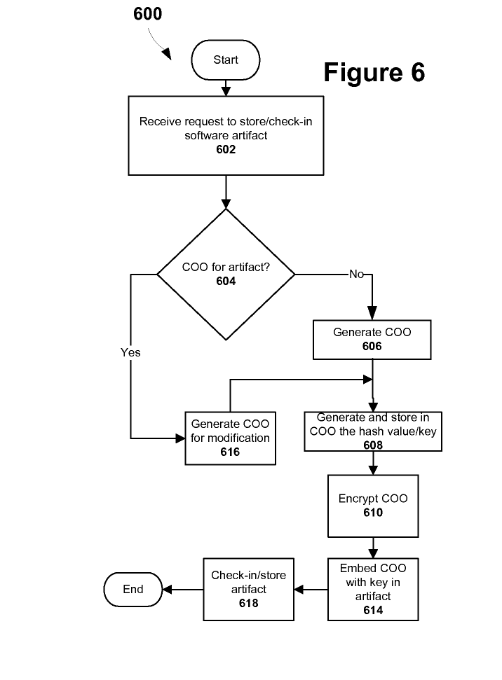

FIG. 6 is an embodiment of a process 600 for generating a COO for an artifact generated by a software developer. Process 600 begins by receiving a request to store and/or check in the artifact with source version control system 310 at block 602. The artifact may be a newly developed artifact or an artifact previously checked out from source version control system 310. At block 604, the process determines if a COO for the artifact is present (e.g., whether a COO for the artifact is embedded in the artifact or otherwise resides in source version control system 310).

If the process, at block 604, determines that a COO is absent for the artifact, the process proceeds to block 606, where the process generates a COO for the artifact. For example, as indicated above, the COO information may be automatically generated (e.g., based on the program, the developer checking in the artifact, etc.), various information may be received from the developer for the COO (e.g., input to a template, in response to a prompt for information from the developer, etc.), or a combination thereof. At block 608, the process generates a hash value/key for the artifact (e.g., key 450 or 550) and stores the hash value/key in the COO. As described above, the hash value/key is generated by hashing all, a portion or some information corresponding to the artifact that may be subsequently used as a checksum to certify the COO for the artifact. At block 610, the process encrypts the COO (e.g., using encryption key 334). At block 614, the COO (and key) is embedded in the artifact. The process checks-in/stores the artifact in source version control system 310 at block 618.

If at block 604 the process determines that a COO for the artifact is present, the process proceeds to block 616 where the process creates a COO corresponding to any modification to the artifact. The process then proceeds to blocks 608, 610 and 614 where a key for the COO is created and the COO/key is encrypted and embedded in the artifact.

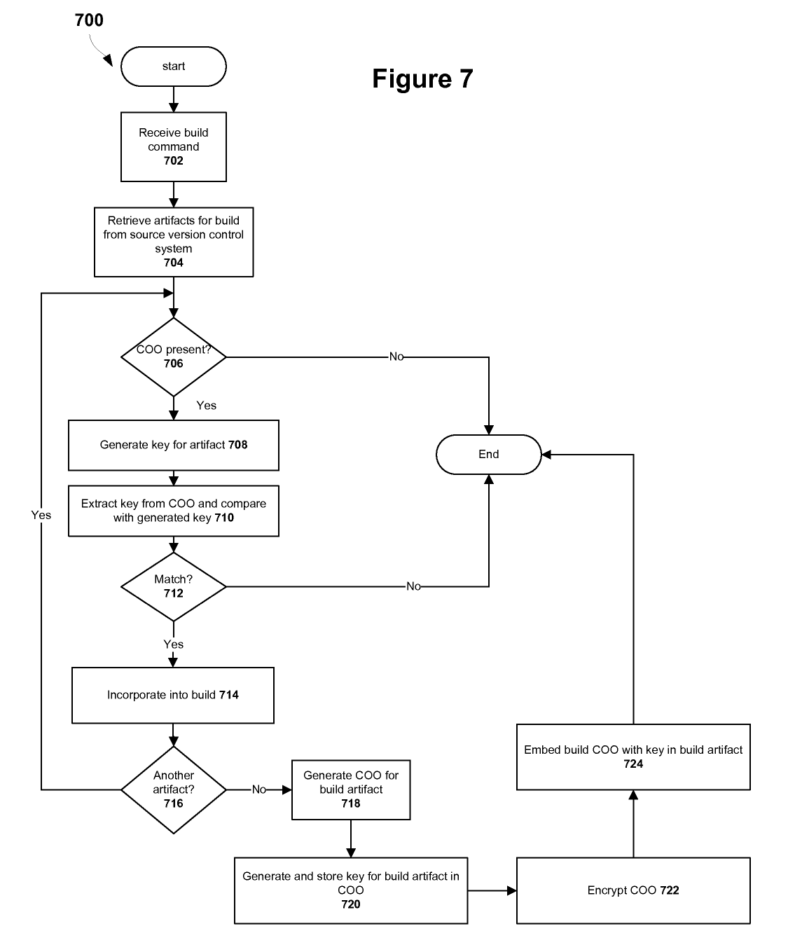

FIG. 7 is an embodiment of a process 700 for building an artifact (e.g., an application) in accordance with the disclosed embodiments. Process 700 begins by receiving a build command at block 702. A build command is a command to compile together all the necessary artifacts to generate an executable version of a software application. The process retrieves all the necessary artifacts from source version control system 310 at block 704. The process then performs a loop for each artifact making up the build artifact by first verifying that a COO for the artifact is present at block 706. If a COO for the artifact is not present, the process terminates (e.g., no build is performed and/or the particular artifact is not included in the build). If the COO is present, the process generates a hash of the artifact at block 708. At block 710, the process compares the hash generated at block 708 with the encrypted key contained in the COO (e.g., encrypted key 450). At block 712, the process determines whether the generated hash matches the COO encrypted key (e.g., a match indicates that the COO is valid for the artifact). If the generated hash does not match the COO encrypted key, the process terminates (e.g., no build is performed and/or the particular artifact is not included in the build). If the generated hash does match the COO encrypted key, the process proceeds to block 714, where the artifact is incorporated into the build artifact. The process determines at block 716 whether another artifact is to be incorporated into the build. If so, the process returns to block 706. If not, the process proceeds to block 718.

At block 718, a COO for the build artifact is generated (e.g., COO information for the build artifact and, if desired, COO information for the component artifacts incorporated into the build artifact in detailed and/or summary form). At block 720, a key (e.g., key 550) is generated for the build artifact (e.g., by hashing all, a portion or some aspect of the build artifact) and stored as part of the COO. At block 722, the process encrypts the COO (e.g., using encryption key 334). At block 724, the build COO with the key is embedded in the build artifact. The process then terminates.

In the process described in connection with FIG. 7, if the hash of the artifact does not match the key contained in the COO of the artifact, the artifact is not included in the build. However, it should be understood that in some embodiments, the process may further evaluate a prior version of the artifact if such a prior version exists in the source version control system for inclusion in the build. For example, if a prior version of the artifact exists in the source version control system and the COO for the prior version is found to be valid, the process may instead incorporate the prior version of the artifact into the build. The process may also notify the requestor of the build that the prior version of the artifact has been used in the build.

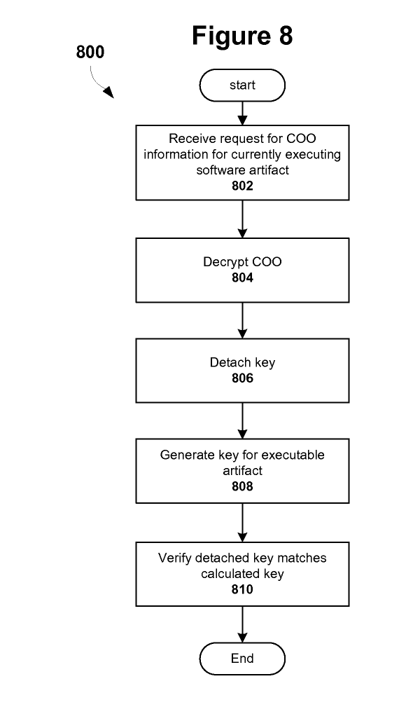

FIG. 8 is an embodiment of a process 800 for accessing a COO of an executable module/artifact in accordance with the disclosed embodiments. Process 800 begins by receiving a request for the COO for a currently executing software artifact at block 802. It should be understood that in some embodiments, in response to a request to launch, execute and/or otherwise access the artifact, the process is self-authenticating such that the COO for the artifact is automatically extracted from the artifact and authenticated as detailed below. At block 804, the process retrieves the COO and decrypts the COO (e.g., using a public key of a private-public key pair). Detach the key for the currently executing software artifact from the COO (e.g., the hash value previously generated for the artifact and stored as part of the COO). The process then generates a hash for the currently executing software artifact at block 806 (e.g., using a hashing algorithm included in and/or otherwise identified by the COO). At block 808, the process verifies that the newly generated hash/key of the artifact matches the key contained in the COO to verify the accuracy of the COO information and the provenance of the artifact content.

Accordingly, the disclosed embodiments present a system, method and computer program product for certifying software origination. The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

In addition, the flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer implemented method comprising:
generating at least one certificate of originality for a software artifact;
generating a key for authenticating the certificate of originality;
incorporating the key into the certificate of originality; and
embedding the certificate of originality in the software artifact.

2. The computer implemented method of claim 1, further comprising providing information about at least one developer of the software artifact in the certificate of originality.

3. The computer implemented method of claim 1, further comprising generating the certificate of originality in response to a request to store the software artifact in a source version control system.

4. The method of claim 1, further comprising creating the key by hashing at least a portion of the software artifact.

5. The method of claim 1, further comprising generating another certificate of originality based on a modification of the software artifact.

6. The method of claim 5, further comprising replacing the key with a key generated based on the modified software artifact.

7. The method of claim 1, further comprising generating the certificate of originality in response to building the software artifact from a plurality of other software artifacts.

8. The method of claim 1, further comprising:
extracting the key from the certificate of originality; and
authenticating the certificate of originality by comparing a hash of at least a portion of the software artifact with the extracted key.

9. The method of claim 1, further comprising:
encrypting the certificate of originality; and
wherein embedding comprises embedding the encrypted certificate of originality in the software artifact.

10. A system comprising:
a data bus system;
memory coupled to the data bus system, wherein the memory includes computer usable program code;
a processing unit coupled to the data bus system, wherein the processing unit executes the computer usable program code to:
generate at least one certificate of originality for a software artifact;
generate a key for authenticating the certificate of originality;
incorporate the key into the certificate of originality; and
embed the certificate of originality in the software artifact.

11. The system of claim 10, wherein the processing unit further executes computer usable program code to generate the certificate of originality in response to a request to store the software artifact in a source version control system.

12. The system of claim 10, wherein the processing unit further executes computer usable program code to generate the certificate of originality in response to a request to store the software artifact in a source version control system.

13. The system of claim 10, wherein the processing unit further executes computer usable program code to create the key by hashing at least a portion of the software artifact.

14. The system of claim 10, wherein the processing unit further executes computer usable program code to generate the certificate of originality in response to building the software artifact from a plurality of other software artifacts.

15. The system of claim 10, wherein the processing unit further executes computer usable program code to encrypt the certificate of originality and embed the encrypted certificate of originality in the software artifact.

16. The system of claim 10, wherein the processing unit further executes computer usable program code to:
extract the key from the certificate of originality; and
authenticate the certificate of originality by comparing a hash of at least a portion of the software artifact with the extracted key.

17. A computer program product comprising:
a tangible computer usable medium including computer usable program code for certifying software origination, the computer usable program code for:
generating at least one certificate of originality for a software artifact;
generating a key for authenticating the certificate of originality;
incorporating the key into the certificate of originality; and
embedding the certificate of originality in the software artifact.

18. The computer program product of claim 17, wherein the computer usable medium includes computer usable program code for encrypting the certificate of originality and embedding the encrypted certificate of originality in the software artifact.

19. The computer program product of claim 17, wherein the computer usable medium includes computer usable program code for creating the key by hashing at least a portion of the software artifact.

20. The computer program product of claim 17, wherein the computer usable medium includes computer usable program code for:
extracting the key from the certificate of originality; and
authenticating the certificate of originality by comparing a hash of at least a portion of the software artifact with the extracted key.
